(19) United States
(12) Patent Application Publication
(10) Pub. No.: US 2020/0226947 A1
(43) Pub. Date: Jul. 16, 2020

(54) MUSIC AND EDUCATION GAMING SYSTEM AND METHOD

(71) Applicant: Rosalind Decell Fowlkes, Baltimore, MD (US)

(72) Inventor: Rosalind Decell Fowlkes, Baltimore, MD (US)

(21) Appl. No.: 16/741,717

(22) Filed: Jan. 13, 2020

Related U.S. Application Data
(60) Provisional application No. 62/791,153, filed on Jan. 11, 2019.

(51) Int. Cl. G09B 15/00; A63F 13/814

(52) U.S. Cl. CPC G09B 15/00; A63F 2300/8047; A63F 13/814

(57) ABSTRACT

Disclosed herein is a music and education gaming system, in accordance with some embodiments. Accordingly, the music and education gaming system may include a visual device, an audio device and a controller. Further, the music and education gaming system may include the computing device communicatively coupled with each of the visual device, the audio device and the controller. Further, the computing device may include a storage device configured for storing a first entity comprising the music audio file and a second entity comprising the educational content. Further, the computing device may include a synchronizer configured for synchronizing the first entity and the second entity. Further, the computing device may include a recorder configured for comparing the play-along feedback with the music audio file. Further, the recorder may be configured for generating performance analytics based on the comparing and storing the performance analytics in the storage device.

The current application claims a priority to the U.S. Provisional Patent application Ser. No. 62/791,153 filed on Jan. 11, 2019. The current application is filed on Jan. 13, 2020 while Jan. 11, 2019 was on a weekend.

### FIELD OF THE INVENTION

Generally, the present disclosure relates to the field of data processing. More specifically, the present disclosure relates to music and education gaming systems and methods.

### BACKGROUND OF THE INVENTION

In present times, individuals are always looking for ways to improve educational games. In conventional systems, educational games oftentimes provide a certain level of entertainment tied to the learning criteria. This certain level of entertainment may actually serve as distraction that is detrimental to the learning process, thus, making these educational games less effective in educating individuals.

Therefore, there is a need for improved methods and systems for facilitating provision of music and educational games that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a music and education gaming system, in accordance with some embodiments. Accordingly, the music and education gaming system may include a visual device configured for generating a visual display based on an educational content and a synchronized data. Further, the music and education gaming system may include an audio device configured for reproducing an audio based on a music audio file and the synchronized data. Further, the music and education gaming system may include a controller communicatively coupled with a computing device. Further, the controller may be configured for receiving a play-along feedback from a user. Further, the user may provide the play-along feedback based on perception of the audio. Further, the music and education gaming system may include the computing device communicatively coupled with each of the visual device, the audio device and the controller. Further, the computing device may include a storage device configured for storing a first entity comprising the music audio file and a second entity comprising the educational content. Further, the computing device may include a storage device a synchronizer communicatively coupled with the storage device. Further, the synchronizer may be configured for synchronizing the first entity and the second entity to generate the synchronized data. Further, the computing device may include a storage device a recorder communicatively coupled with the storage device. Further, the recorder may be configured for comparing the play-along feedback with the music audio file based on at least one performance metric. Further, the recorder may be configured for generating performance analytics based on the comparing. Further, the recorder may be configured for storing the performance analytics in the storage device.

Further disclosed herein is a music and education gaming method, in accordance with some embodiments. Further, the music and education gaming method may include receiving, using a storage device, a first entity comprising a music audio file and a second entity comprising an educational content. Further, the music and education gaming method may include synchronizing, using a synchronizer, the first entity and the second entity to generate a synchronized data. Further, the music and education gaming method may include generating, using a visual device, a visual display based on the educational content and the synchronized data. Further, the music and education gaming method may include reproducing, using an audio device, an audio based on the music audio file and the synchronized data. Further, the music and education gaming method may include receiving, using a controller, a play-along feedback from a user. Further, the user may provide the play-along feedback based on perception of the audio. Further, the music and education gaming method may include comparing, using recorder, the play-along feedback with the music audio file based on at least one performance metric. Further, the music and education gaming method may include generating, using the recorder, performance analytics based on the comparing. Further, the music and education gaming method may include storing, using the recorder, the performance analytics in the storage device.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a block diagram of a music and education gaming system, in accordance with some embodiments.

FIG. 3 is a flowchart of a music and education gaming method, in accordance with some embodiments.

FIG. 4 is a flowchart of a music and education gaming method, in accordance with some embodiments.

FIG. 5 is a block diagram of a music and education gaming system, in accordance with some embodiments.

FIG. 6 is a flowchart of a method for setting up the software, in accordance with some embodiments.

FIG. 7 is a flowchart of a method for initiating a session, in accordance with some embodiments.

FIG. 8 is a block diagram of a system for executing a session, in accordance with some embodiments.

FIG. 9 is a flowchart of a method for executing a session, in accordance with some embodiments.

FIG. 10 is a block diagram of a computing device for implementing the methods disclosed herein, in accordance with some embodiments.

### DETAILED DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of music and education gaming system and method, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

Overview:

The present disclosure may utilize music play-along software in the educational gaming process, wherein the music play-along software serves as both an educational and entertaining functions. Integrating music play-along learning mechanics into the educational gaming process stimulates memorization, having the user follow along in rhythm and in symphony. The embodiments of the present disclosure may accommodate various users such as: children, teenagers, adults, elderly, etc. Further, the embodiments of the present disclosure may adapt to different types of hardware, allowing individuals to connect in actual digital instruments along with the computer keyboard.

According to some embodiments, the present disclosure plays the music with the music notes connected in computer gaming for the process of building a computer. According to some embodiments, a software application that may guide the user through on how to build a computer may be disclosed.

According to some embodiments, the present disclosure uses laptop and desktop to educate individuals on how to play the piano or organ. Further, the present disclosure teaches using a software for educational purposes such as games to build a computer. Further, the keyboard may also be taken out to switch to a regular keyboard for regular use of a computer. A first software game may let users play to a certain point then provide users with several steps to building a laptop or desktop. A second software may be an operating system and the third software may be the basics to experienced when playing a piano or organ. Additionally, the clef symbol may be the choice for design on top of the laptop or desktop for viewing.

According to some embodiments, the present disclosure uses laptop that may turn into an organ or a piano. The disclosure teaches a new developed educational software for how to play the piano to play the organ as well as educational gaming software. The organ may have a new developed simple software on how to play the piano and rewards after a certain step. The new developed gaming software may have one person play a game with how many points they have to the first several steps of building or refurbishing a laptop.

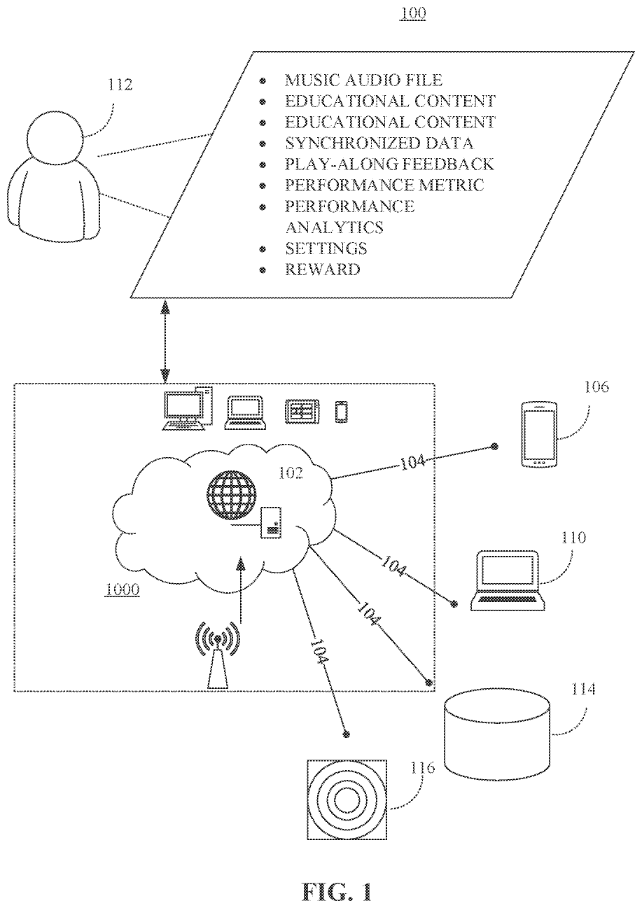

FIG. 1 is an illustration of an online platform 100 consistent with various embodiments of the present disclosure. By way of non-limiting example, the online platform 100 to facilitate a music and education gaming system and method may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), databases 114, and sensors 116 over a communication network 104, such as, but not limited to, the Internet. Further, users of the online platform 100 may include relevant parties such as, but not limited to, end-users, administrators, service providers, service consumers and so on. Accordingly, in some instances, electronic devices operated by the one or more relevant parties may be in communication with the platform 100.

A user 112, such as the one or more relevant parties, may access online platform 100 through a web based software application or browser. The web based software application may be embodied as, for example, but not be limited to, a website, a web application, a desktop application, and a mobile application compatible with a computing device 1000.

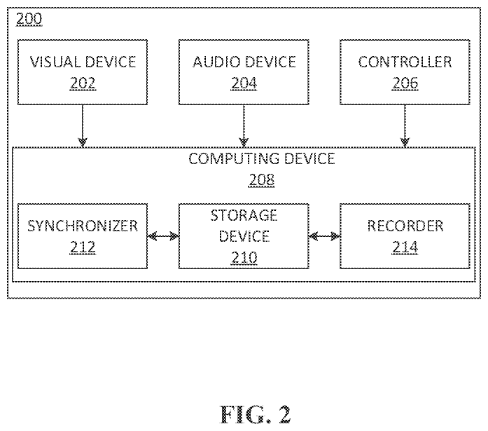

FIG. 2 is a block diagram of a music and education gaming system 200, in accordance with some embodiments. Accordingly, the music and education gaming system 200 may include a visual device 202 configured for generating a visual display based on an educational content and a synchronized data. In some embodiments, the educational content may include Do It Yourself (DIY) instructions. In some embodiments, the educational content may include at least one of an audio effect and a video effect paired with the educational content.

Further, the music and education gaming system 200 may include an audio device 204 configured for reproducing an audio based on a music audio file and the synchronized data.

Further, the music and education gaming system 200 may include a controller 206 communicatively coupled with a computing device 208. Further, the controller 206 may be configured for receiving a play-along feedback from a user. Further, the user may provide the play-along feedback based on perception of the audio.

In some embodiments, the controller 206 may include at least one of a computer keyboard controller devices and an instrumental controller.

In some embodiments, the controller 206 may include at least one of a digital keyboard, a digital string instrument, and a digital percussion instrument. Further, the educational content may include (DIY) instructions for repairing at least one of an electronic device and an electrical device. Further, providing the play-along feedback may facilitate learning of a musical instrument

Further, the music and education gaming system 200 may include the computing device 208 communicatively coupled with each of the visual device 202, the audio device 204 and the controller 206.

Further, the computing device 208 may include a storage device 210 configured for storing a first entity comprising the music audio file and a second entity comprising the educational content. In some embodiments, the first entity may include at least one of a format, a genre, a tone and a rhythm. In some embodiments, the first entity may include at least one of a classical music piece, a nursery rhymes, and an urban music.

Further, the computing device 208 may include a synchronizer 212 communicatively coupled with the storage device 210. Further, the synchronizer 212 may be configured for synchronizing the first entity and the second entity to generate the synchronized data.

Further, the computing device 208 may include a recorder 214 communicatively coupled with the storage device 210. Further, the recorder 214 may be configured for comparing the play-along feedback with the music audio file based on at least one performance metric. In some embodiments, the at least one performance metric may include at least one of an accuracy associated with the play-along feedback and a timing associated with the play-along feedback.

Further, the recorder 214 may be configured for generating performance analytics based on the comparing. Further, the recorder 214 may be configured for storing the performance analytics in the storage device 210.

In further embodiments, the recorder 214 may be configured for generating a congratulatory reward comprising at least one of a visual data and an audio data based on the performance analytics. Further, the audio device 204 may reproduce the audio based on the audio data and the visual device 202 generates the visual display based on the visual data.

In further embodiments, the computing device 208 may include an animation module configured for animating the educational content.

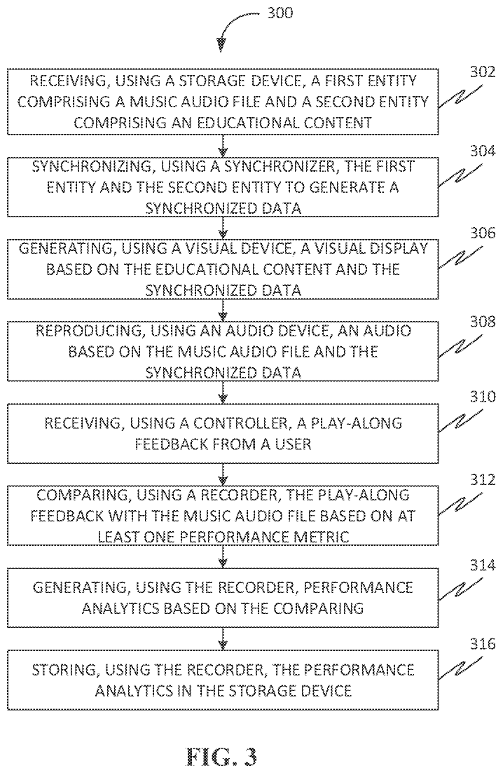

FIG. 3 is a flowchart of a music and education gaming method 300, in accordance with some embodiments. Accordingly, at 302, the music and education gaming method 300 may include a step of receiving, using a storage device (such as the storage device 210), a first entity comprising a music audio file and a second entity comprising an educational content. In some embodiments, the first entity may include at least one of a format, a genre, a tone and a rhythm. In some embodiments, the first entity may include at least one of a classical music piece, a nursery rhymes, and an urban music.

Further, at 304, the music and education gaming method 300 may include a step of synchronizing, using a synchronizer (such as the synchronizer 212), the first entity and the second entity to generate a synchronized data.

Further, at 306, the music and education gaming method 300 may include a step of generating, using a visual device (such as the visual device 202), a visual display based on the educational content and the synchronized data. In some embodiments, the educational content may include Do It Yourself (DIY) instructions. In some embodiments, the educational content may include at least one of an audio effect and a video effect paired with the educational content.

Further, at 308, the music and education gaming method 300 may include a step of reproducing, using an audio device (such as the audio device 204), an audio based on the music audio file and the synchronized data.

Further, at 310, the music and education gaming method 300 may include a step of receiving, using a controller (such as the controller 206), a play-along feedback from a user, wherein the user provides the play-along feedback based on perception of the audio. In some embodiments, the controller may include at least one of a computer keyboard controller devices and an instrumental controller. In some embodiments, the controller may include at least one of a digital keyboard, a digital string instrument, and a digital percussion instrument. Further, the educational content may include (DIY) instructions for repairing at least one of an electronic device and an electrical device. Further, providing the play-along feedback may facilitate learning of a musical instrument.

Further, at 312, the music and education gaming method 300 may include a step of comparing, using a recorder (such as the recorder 214), the play-along feedback with the music audio file based on at least one performance metric. In some embodiments, the at least one performance metric may include at least one of an accuracy associated with the play-along feedback and a timing associated with the play-along feedback

Further, at 314, the music and education gaming method 300 may include a step of generating, using the recorder, performance analytics based on the comparing.

Further, at 316, the music and education gaming method 300 may include a step of storing, using the recorder, the performance analytics in the storage device.

In further embodiments, the music and education gaming method 300 may include a step of animating, using an animation module, the educational content.

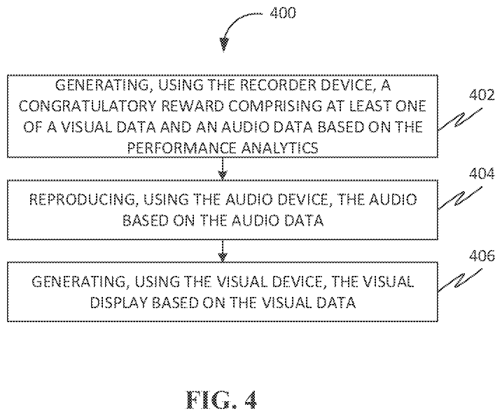

FIG. 4 is a flowchart of a music and education gaming method 400, in accordance with some embodiments. Accordingly, at 402, the music and education gaming method 400 may include a step of generating, using the recorder, a congratulatory reward comprising at least one of a visual data and an audio data based on the performance analytics.

Further, at 404, the music and education gaming method 400 may include a step of reproducing, using the audio device, the audio based on the audio data.

Further, at 406, the music and education gaming method 400 may include a step of generating, using the visual device, the visual display based on the visual data.

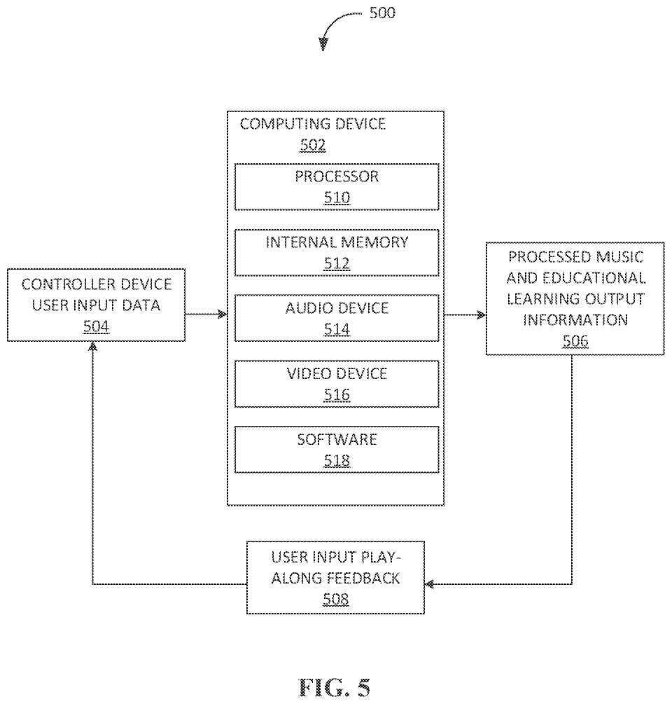

FIG. 5 is a block diagram of a music and education gaming system 500, in accordance with some embodiments. Further, the music and education gaming system 500 may be embodied as an executable program that may combine musical learning aspects into educational gaming mechanics. Further, the music and education gaming system 500 may streamline the learning process by allowing a user to play and learn in a comfortable and entertaining pace. Further, the music and education gaming system 500 may stimulate physiological and cognitive memory mechanics associative with learning. Further, the music and education gaming system 500 may include the required hardware and software to perform the required operations. Further, the music and education gaming system 500 may include compatible hardware that may upload and execute the software. I

In various embodiments, the music and education gaming system 500 may include multiple port embodiments to optimize hardware performance functionality. The music and education gaming system 500 may include one or more of a computing device 502, a controller 504, an audio device 514, and a visual device 516. The computing device 502 may include a processing device 510 and an internal memory 512.

Further, the computing device 502 may be adapted to the music and education gaming system 500. More specifically, the computing device 502 may take form of any type of compatible computer device such as, but not limited to, laptop computers, desktop computers, portable smart devices, gaming consoles, etc.

Further, the controller 504 may be adapted to the music and education gaming system 500. Additionally, the controller 504 may operate in conjunction with the computing device 502. More specifically, the controller 504 may take form of any type of compatible controller device such as, but not limited to, computer keyboard controller devices and/or instrumental controllers. Further, the controller 504 may allow the user to navigate the music and education gaming system 500 through the usage of a computer keyboard. In various embodiments, the controller 504 may include various ports to support instrumental controllers including, but not limited to, digital keyboards, digital string instruments, digital percussion instruments, and/or any other compatible digital music instrument.

Further, the audio device 514 may be adapted to the music and education gaming system. Additionally, the audio device 514 may be connected to the computing device 502. More specifically, the audio device 514 may take form of any type of compatible audio emitting device including, but not limited to, audio speakers, audio headsets, amplifiers, etc.

Further, the visual device 516 may be adapted to the music and education gaming system 500. Additionally, the visual device 516 may be connected to the computing device 502. More specifically, the visual device 516 may take form of any type of compatible visualizer apparatus including, but not limited to, computer monitors, television screens, projectors, etc.

Further, the music and education gaming system 500 may include a software 518, particularly tied into the corresponding computing device 502. More specifically, the software 518 is an executable program application that runs the music and education gaming system 502. In various embodiments, the software 518 may include various ports/adaptations to run on its respective corresponding computing device 502. Further, the software 518 may include a downloader, a network, a registry, a tracker, a dashboard, and a session.

Further, the controller 504 may be configured for receiving a play-along feedback 508 from a user. Further, the user may provide the play-along feedback 508 based on perception of the audio. Further, the computing device 502 may provide a processed music and educational learning output information 506.

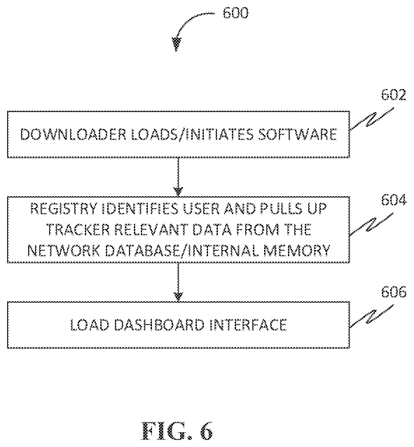

FIG. 6 is a flowchart of a method 600 for setting up the software 518, in accordance with some embodiments. Accordingly, at 602, the method 600 may include the downloader setting up the software 518 into the corresponding computing device 502. Additionally, the downloader sets up the necessary plug-ins/ports for the corresponding controller device. Further, the network may serve as the database storage repository for the music and education gaming system 500. Further, the network may store data in the direct memory storage medium (the internal memory 512) of the computer device 502. Further, the network may store data through wireless data storage means, where such data may be stored in a cloud-based storage system (such as the centralized server 102).

Further, the registry may reside in the software 518, particularly linked to the network. More specifically, the registry may serve as the user input data logger module that allows the user to sign up, and/or sign in to their respective account credentials.

Further, at 604, the method 600 may include the registry identifying the user based on their respective login credentials and pulls up associative data from the network. Further, the tracker may reside in the software 518, particularly working in conjunction with the registry and the network. More specifically, the tracker may record the progress and accolades of the registered user. Further, the tracker may save the registered user's progress. Further, at 606, the method 600 may include loading a dashboard interface.

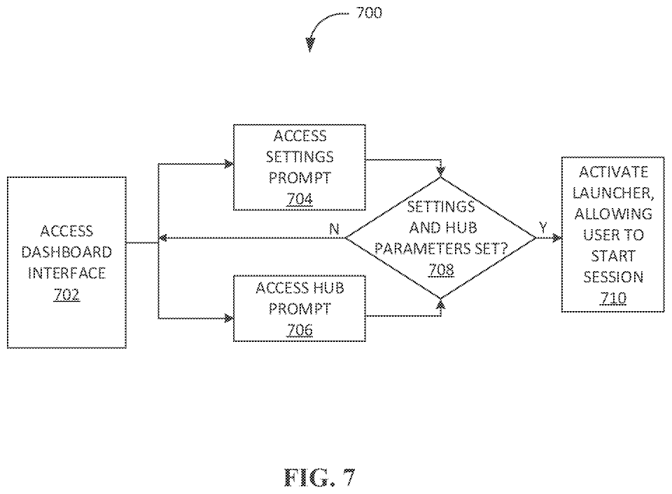

FIG. 7 is a flowchart of a method 700 for initiating a session, in accordance with some embodiments. Further, the dashboard may reside in the software 518, serving as the main user interface of the software 518, and proceeds upon initiation and registry of the software 518. More specifically, the dashboard may be the main interface platform of the software 518 that may allow the user to set up and customize training sessions. The dashboard interface may further include a settings prompt, a hub prompt, and a launcher. Accordingly, at 702, the method 700 may include a user accessing a dashboard interface.

Further, at 704, the method 700 may include the user accessing the settings prompt through the dashboard interface. More specifically, the setting prompt may allow the user to customize session relevant aspects that affect gameplay. Further, the settings prompt may allow the user configure aspects including, but not limited to, music interface layout, i.e. clef symbol toggling, education interface layout visuals, audio pre-sets, etc.

Further, at 706, the method 700 may include the user accessing the hub prompt through the dashboard and accessing the database network. More specifically, the hub prompt may serve as the session selection prompt that allows the user to set the specific session to be played once the session is initiated. Further, the hub prompt may include pre-configured musical and education sessions within the internal memory database network. Further, the hub prompt may include downloadable session content, accessible through a cloud-based network storage database. Additionally, the hub prompt may allow the user to create their own sessions, provided the proper and/or compatible session file-formats.

Further, the hub prompt may further include a plurality of scripts. The plurality of scripts may be incorporated within the hub prompt. More specifically, the plurality of scripts may serve as the playable session file-formats that run the session audio, video, and/or game mechanics. The plurality of scripts may further include a first entity, a second entity, and a synchronizer.

Further, the first entity may take form of the supported music audio file that may play during the session. Further, the first entity may take form of any compatible format, genre, tone, and/or rhythm. Further, the first entity may take form of classical music pieces, nursery rhymes, urban, etc.

Further, the second entity may be paired with the first entity. More specifically, the second entity may take educational and/or instructional audio/video files that may play during the session. Further, the second entity may take form of educational, and/or DIY (do-it-yourself) textual instructions, paired with audio and/or video effects.

Further, the synchronizer may serve as an audio/visual processor that processes the paired first entity and second entity files into compatible data that seamlessly runs along the session process.

Further, at 708, the method 700 may include determining if the settings and hub parameters have been set.

Further, at 710, the method 700 may include activating a launcher allowing user to start session. The launcher may be found in the dashboard. The launcher may be activated upon user selection and/or configuration of the settings prompt and the hub prompt in formulating a selected session. More specifically, the launcher may serve as the session gateway of the dashboard that initiates the session game process.

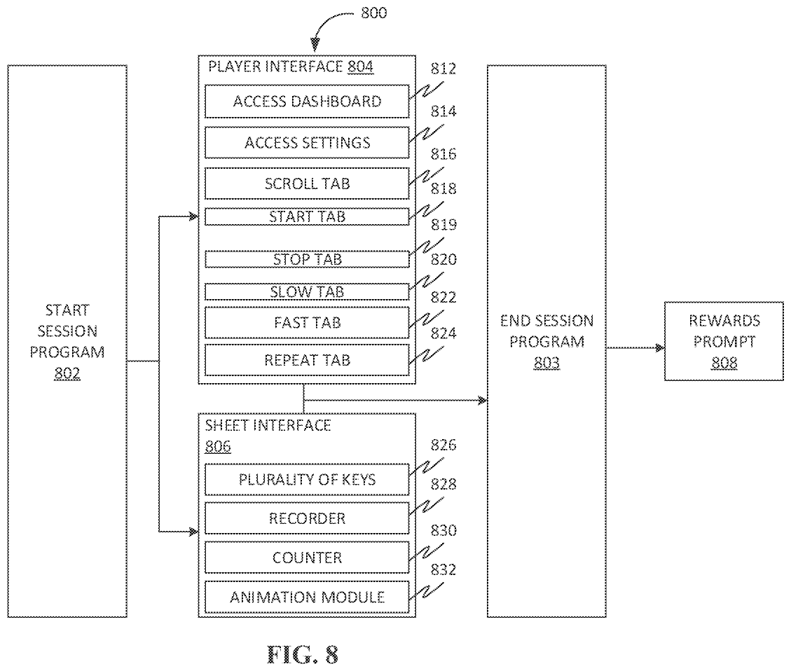

FIG. 8 is a block diagram of a system 800 for executing a session, in accordance with some embodiments. Further, the session may be initiated upon user activation of the launcher. More specifically, the session may serve as the gaming process of the music and education gaming system 500. Upon initiation, the session begins the musical/rhythm-based game, deriving processed data from the first entity, requiring the user to hit the required notes as the music plays on. Further, the music/rhythm-based game takes form of a play-along, specifically serving as a teaching aid in learning the selected tune. During the musical/rhythm-based game, the session may also display the educational visuals, deriving processed data from the second entity, requiring the user to follow along the educational visuals while performing musical/rhythm-based game actions. Further, the educational visuals may take form of integrated text/audio/video representations within the music/rhythm-based game. Once the session ends, the performance analytics may be logged within the tracker and stored within the network database.

The session may start at 802 and end at 803. The session may include a player interface 804, a sheet interface 806, and a rewards prompt 808.

Further, the player interface 804 may be found in the session process. More specifically, the player interface 804 may allow the user to control the musical/rhythm-based game during the play session. The player interface 804 may allow the user to edit, customize and set conditional parameters to dictate which sections of the session should be played. The player interface 804 further includes one or more of an accessing dashboard tab 812, an access settings tab 814, a scroll tab 816, a start tab 818, a stop tab 819, a slow tab 820, a fast tab 822, and a repeat tab 824.

Further, the scroll tab 816 allows the user to swipe the specific time duration/section of the session they wish to play. The start tab 818 allows the user to continue the selected time direction/section of the session they wish to play. The stop tab 819 allows the user to pause the session in progress. The slow tab 820 allows the user to tone down the tempo of the session in progress. The fast tab 822 allows the user to tone up the tempo of the session in progress. The repeat tab 824 allows the user to loop the selected time direction/section of the session.

Further, the c is found in the session process. More specifically, the sheet interface 806 serves as the music/rhythm game visualizer that works in conjunction with the information derived from the hub, particularly from the paired first entity and second entity script data. Further, the sheet interface 806 displays the video, and/or textual aspects of the first entity and the second entity. The sheet interface 806 further comprises a plurality of keys 826, a recorder 828, a counter 830, and an animation module 832.

Further, the plurality of keys 826 serves as the processed music-note information that requires the user to input the proper respective key. Further, the plurality of keys 826 may take form of tempo forming musical notes that works in conjunction with the user input controller functions. Further, the plurality of keys 826 activates the audio output of the session, emulating music instrument playing aspects.

Further, the recorder 828 serves as the input-key registration node that determines whether the plurality of keys is being followed along properly along the user input key commands of the controller. Further, the recorder 828 gathers user input data based on accuracy, timing, and/or any other performance-based data analytics.

Further, the counter 830 may be a visual queue that shows the user the basic data analytics generated by the recorder when a session is in progress. Further, the animation module 832 may embody the environmental layout of the sheet interface that displays video, and/or textual imaging based on setting configuration parameters, and user-selected hub information. Further, the animation module 832 supplements the music and rhythm game, particularly in displaying instructional/educational visuals.

Further, the rewards prompt 808 initiates upon completion of the session process. More specifically, the rewards prompt 808 concludes the session by presenting congratulatory audio/video output. Further, the rewards prompt 808 also directs the user back to the dashboard.

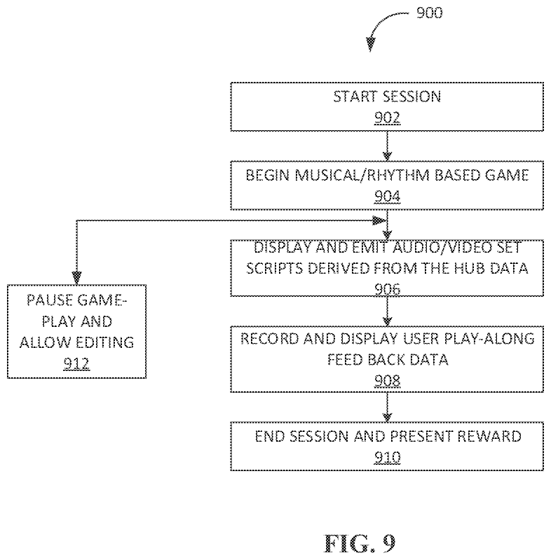

FIG. 9 is a flowchart of a method 900 for executing a session, in accordance with some embodiments. Accordingly, at 902, the method 900 may include starting a session. Further, at 904, the method 900 may include beginning musical/rhythm based game. Further, at 906, the method 900 may include displaying and emitting audio/video set scripts derived from the hub data. Further, at 908, the method 900 may include recording and displaying user play-along feedback data. Further, at 910, the method 900 may include ending session and presenting reward. Further, at 912, the method 900 may include pausing game-play and allowing editing.

In some embodiments, the music and education gaming system 500 may teach users how to play the piano, as well as learning how to repair a laptop. Specifically, the controller 504 takes form of a digital keyboard instrument outfitted onto the computing device. The software downloader then takes measures assuring that the appropriate plug-ins and/or ports are loaded to assure that the digital keyboard instrument serves as the controller to the software. Upon start-up of the software 518, the registry pulls up all relevant saved data from the network internal memory 512 within the computing device 502 and directs the user to the dashboard. In the dashboard, the user then selects the appropriate settings and hub parameters. The settings may include, but is not limited to, configurations to graphical overlay parameters, and/or performance-based parameters that affect gameplay.

Upon access in the hub, the user selects the scripts of interest comprising the music file and the educational instructable file. In this instance, the music selection may vary dependent on the user's preference, and/or optimization/compatibility with the selected educational instructable and/or instrument. This music selection may vary depending on music genres including, but not limited to, classical music, urban, etc. The educational instructable, in this instance, selected may be teaching the user how to repair a laptop but may be any type of educational instructable.

Once the settings and hub parameters have been fulfilled, the user may then launch the session. The user is then presented with the music and education-based rhythm style game. This music and education-based rhythm style game may require the user to play-along the music file, having the user hit a plurality of keys shown on the display. If a note has been hit corrected, the instrumental audio may play. Simultaneously, the education-based rhythm style game may display the uploaded educational instructable on “how to build a computer” along the music. In this instance, the play-along music and uploaded educational instructable is broken into segments, allowing the user to repeat these segments until they may memorize whole verses of the play-along music as well as the instructable segment. The total amount of these instructable segments and music verses may make up the whole session, for example:

First Music Verse/Parts List Instructable Segment:

1. Electro Static Device (ESD) wrist band

2. Electro Static (ESD) MAT

3. Electronic screwdriver set (Magnetic to reach parts that has fallen inside of unplugged computer)

4. Thread adhesive laptop screws (EXTRAS)

5. Small flash light (Just in Case You Need It)

6. Mild cleaner (Windex® Electronics Wipes) for LCD (screen) and soft rag

7. Can of air (blow off dust inside of computer)

Second Music Verse/Prepare Your Workstation Instructable Segment:

1. Create a large, flat, and well lighted work space to lay out your components and parts.

2. Put on your Electro Static Device (ESD) WRIST BAND

3. Lay ESD mat on the table

4. Lay tools neatly on ESD MAT

5. Lay parts neatly on the ESD MAT (keep memory in ESD bag until needed)

Third Music Verse/Installation of System Memory Instructable Segment:

1. Put on your Electro Static Device (ESD) wrist band

2. Disconnect Power (AC adapter)

3. Disconnect Battery (Primary Battery)

4. Disconnect any other cords or wire (sit until cool)

5. Turn laptop face down gently to take off door on the other side of the laptop

6. Open memory door or cover using a Phillip screw driver. (looks like an x at the tip of screw driver)

7. There may be one or two slots to take memory from.

8. Gently pull up the leaver on both sides of the memory. Then take memory out

9. If needed spray inside to clear dust with can of air

10. Slide memory in the direction it was taken out (the gold piece called connectors into the slot)

11. You may hear a click to let you know it is seated correctly

12. Put memory door on (screw doors closed)

13. Clean laptop with mild electronic cleaner (Windex® Electronics Wipes)

Final Music Verse/after Installation of Your System's Memory Instructable Segment:

1. The main battery must be put back in place

2. Turn your laptop right side up

3. Connect AC adapter (power cord) and wires

4. Restart laptop

In this particular instance, the session may end when each verse (from the first verse to the final verse) has been played along/followed through accurately. When the session ends, the music and education gaming system may then follow up with a congratulatory reward in form of a visual and/or audio signal. The rewards prompt also displays the current accolades and achievements of the session that was completed.

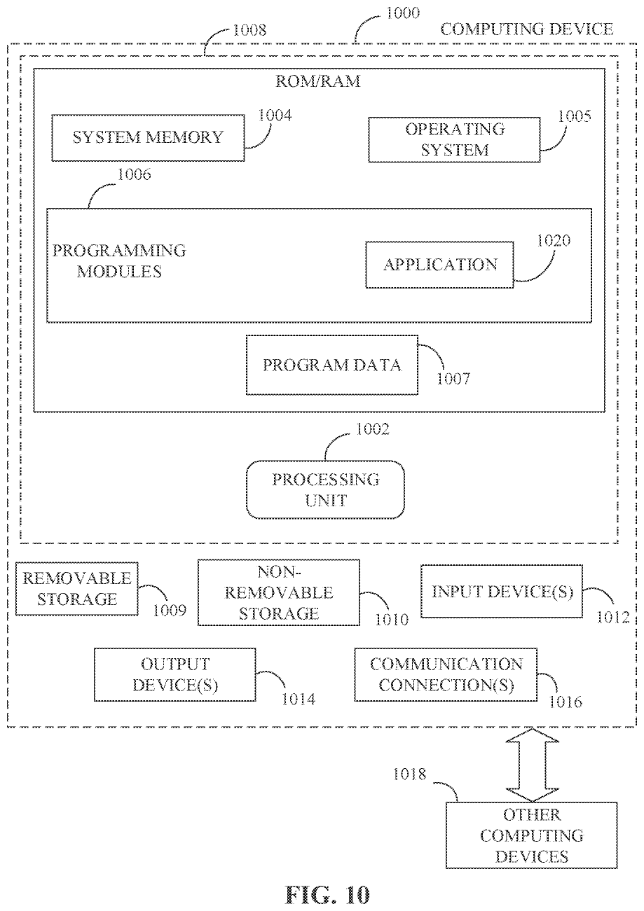

With reference to FIG. 10, a system consistent with an embodiment of the disclosure may include a computing device or cloud service, such as computing device 1000. In a basic configuration, computing device 1000 may include at least one processing unit 1002 and a system memory 1004. Depending on the configuration and type of computing device, system memory 1004 may comprise, but is not limited to, volatile (e.g. random-access memory (RAM)), non-volatile (e.g. read-only memory (ROM)), flash memory, or any combination. System memory 1004 may include operating system 1005, one or more programming modules 1006, and may include a program data 1007. Operating system 1005, for example, may be suitable for controlling computing device 1000's operation. In one embodiment, programming modules 1006 may include image-processing module, machine learning module. Furthermore, embodiments of the disclosure may be practiced in conjunction with a graphics library, other operating systems, or any other application program and is not limited to any particular application or system. This basic configuration is illustrated in FIG. 10 by those components within a dashed line 1008.

Computing device 1000 may have additional features or functionality. For example, computing device 1000 may also include additional data storage devices (removable and/or non-removable) such as, for example, magnetic disks, optical disks, or tape. Such additional storage is illustrated in FIG. 10 by a removable storage 1009 and a non-removable storage 1010. Computer storage media may include volatile and non-volatile, removable and non-removable media implemented in any method or technology for storage of information, such as computer-readable instructions, data structures, program modules, or other data. System memory 1004, removable storage 1009, and non-removable storage 1010 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1000. Any such computer storage media may be part of device 1000. Computing device 1000 may also have input device(s) 1012 such as a keyboard, a mouse, a pen, a sound input device, a touch input device, a location sensor, a camera, a biometric sensor, etc. Output device(s) 1014 such as a display, speakers, a printer, etc. may also be included. The aforementioned devices are examples and others may be used.

Computing device 1000 may also contain a communication connection 1016 that may allow device 1000 to communicate with other computing devices 1018, such as over a network in a distributed computing environment, for example, an intranet or the Internet. Communication connection 1016 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1004, including operating system 1005. While executing on processing unit 1002, programming modules 1006 (e.g., application 1020 such as a media player) may perform processes including, for example, one or more stages of methods, algorithms, systems, applications, servers, databases as described above. The aforementioned process is an example, and processing unit 1002 may perform other processes.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

What is claimed is:

1. A music and education gaming system comprising:
a visual device configured for generating a visual display based on an educational content and a synchronized data;
an audio device configured for reproducing an audio based on a music audio file and the synchronized data;
a controller communicatively coupled with a computing device, wherein the controller is configured for receiving a play-along feedback from a user, wherein the user provides the play-along feedback based on perception of the audio; and
the computing device communicatively coupled with each of the visual device, the audio device and the controller, wherein the computing device comprises:
a storage device configured for storing a first entity comprising the music audio file and a second entity comprising the educational content;
a synchronizer communicatively coupled with the storage device, wherein the synchronizer is configured for synchronizing the first entity and the second entity to generate the synchronized data;
a recorder communicatively coupled with the storage device, wherein the recorder is configured for:
comparing the play-along feedback with the music audio file based on at least one performance metric;
generating performance analytics based on the comparing; and
storing the performance analytics in the storage device.

2. The music and education gaming system of claim 1, wherein the first entity comprises at least one of a format, a genre, a tone and a rhythm.

3. The music and education gaming system of claim 2, wherein the first entity comprises at least one of a classical music piece, a nursery rhymes and an urban music.

4. The music and education gaming system of claim 1, wherein the educational content comprises Do It Yourself (DIY) instructions.

5. The music and education gaming system of claim 1, wherein the educational content further comprises at least one of an audio effect and a video effect paired with the educational content.

6. The music and education gaming system of claim 1, wherein the at least one performance metric comprises at least one of an accuracy associated with the play-along feedback and a timing associated with the play-along feedback.

7. The music and education gaming system of claim 1, wherein the recorder is further configured for generating a congratulatory reward comprising at least one of a visual data and an audio data based on the performance analytics, wherein the audio device reproduces the audio based on the audio data and the visual device generates the visual display based on the visual data.

8. The music and education gaming system of claim 1, wherein the computing device further comprises an animation module configured for animating the educational content.

9. The music and education gaming system of claim 1, wherein the controller comprises at least one of a computer keyboard controller devices and an instrumental controller.

10. The music and education gaming system of claim 1, wherein the controller comprises at least one of a digital keyboard, a digital string instrument, and a digital percussion instrument, wherein the educational content comprises (DIY) instructions for repairing at least one of an electronic device and an electrical device, wherein providing the play-along feedback facilitates learning of a musical instrument.

11. A music and education gaming method comprising:
receiving, using a storage device, a first entity comprising a music audio file and a second entity comprising an educational content;
synchronizing, using a synchronizer, the first entity and the second entity to generate a synchronized data;
generating, using a visual device, a visual display based on the educational content and the synchronized data;
reproducing, using an audio device, an audio based on the music audio file and the synchronized data;
receiving, using a controller, a play-along feedback from a user, wherein the user provides the play-along feedback based on perception of the audio;
comparing, using a recorder, the play-along feedback with the music audio file based on at least one performance metric;
generating, using the recorder, performance analytics based on the comparing; and
storing, using the recorder, the performance analytics in the storage device.

12. The music and education gaming method of claim 11, wherein the first entity comprises at least one of a format, a genre, a tone and a rhythm.

13. The music and education gaming method of claim 12, wherein the first entity comprises at least one of a classical music piece, a nursery rhymes and an urban music.

14. The music and education gaming method of claim 11, wherein the educational content comprises Do It Yourself (DIY) instructions.

15. The music and education gaming method of claim 11, wherein the educational content further comprises at least one of an audio effect and a video effect paired with the educational content.

16. The music and education gaming method of claim 11, wherein the at least one performance metric comprises at least one of an accuracy associated with the play-along feedback and a timing associated with the play-along feedback.

17. The music and education gaming method of claim 11 further comprising:
generating, using the recorder, a congratulatory reward comprising at least one of a visual data and an audio data based on the performance analytics;
reproducing, using the audio device, the audio based on the audio data; and
generating, using the visual device, the visual display based on the visual data.

18. The music and education gaming method of claim 11 further comprising animating, using an animation module, the educational content.

19. The music and education gaming method of claim 11, wherein the controller comprises at least one of a computer keyboard controller devices and an instrumental controller.

20. The music and education gaming method of claim 11, wherein the controller comprises at least one of a digital keyboard, a digital string instrument, and a digital percussion instrument, wherein the educational content comprises (DIY) instructions for repairing at least one of an electronic device and an electrical device, wherein providing the play-along feedback facilitates learning of a musical instrument.
